(19) United States
(12) Patent Application Publication
(10) Pub. No.: US 2015/0043653 A1
(43) Pub. Date: Feb. 12, 2015

(54) TECHNIQUES FOR LOW POWER VIDEO COMPRESSION AND TRANSMISSION

(71) Applicants: Zhiwei Ying, Shanghai (CN); Changliang Wang, Bellevue, WA (US)

(72) Inventors: Zhiwei Ying, Shanghai (CN); Changliang Wang, Bellevue, WA (US)

(21) Appl. No.: 14/128,610

(22) PCT Filed: Aug. 12, 2013
(86) PCT No.: PCT/CN2013/081274

§ 371 Date: Aug. 20, 2014

(51) Int. Cl. H04N 19/13; H04N 19/91

(52) U.S. Cl. CPC H04N 19/00121; H04N 19/00951
USPC 375/240.23

(57) ABSTRACT

Various embodiments are generally directed to techniques for reducing the consumption of electric power in compressing and transmitting video to a display device by analyzing a degree of difference between adjacent frames and dynamically selecting a type of compression per frame depending on the degree of difference. A device to compress video frames includes a processor component, and a compression selector for execution by the processor component to dynamically select a type of compression for a current frame of a series of frames based on a degree of difference between the current frame and a preceding adjacent frame of the series of frames. Other embodiments are described and claimed.

### CROSS-REFERENCE TO RELATED APPLICATION

Attention is drawn to a subject-matter related application filed concurrently herewith by the inventors named herein, entitled TECHNIQUES FOR LOW POWER IMAGE COMPRESSION AND DISPLAY (attorney docket number P55778PCT).

### TECHNICAL FIELD

Embodiments described herein generally relate to reducing power consumption in compressing and transmitting video.

### BACKGROUND

In transmitting video to a display device for visual presentation, various forms of video compression are typically employed, including various versions of the widely used Motion Picture Experts Group (MPEG) specification promulgated by the International Organization for Standardization of Geneva, Switzerland. Unfortunately, such forms of video compression employ an assortment of processor-intensive calculations for each transmitted frame of video that consume a considerable amount of electric power. This can become a significant issue when the transmission emanates from a portable computing device relying upon a battery for the electric power to perform such calculations.

These calculations were devised based largely on the assumption that the transmitted video includes motion video in which there is a relatively high rate of change across relatively large numbers of pixels between adjacent frames. Such assumptions arise from the statistically frequent occurrence of movement of objects in typical motion video generated through the capture of real world imagery. The movement of people and objects, as well as pan and zoom camera motions, typically found in such motion video results in the shifting of positions of objects across relatively large numbers of pixels between adjacent frames. These calculations, therefore, include mathematically derived indications of direction and extent of movement of pixel color values for relatively large blocks of pixels between frames.

So strong are these expectations of such significant instances of movement that at least some of these calculations are performed for every frame without regard to whether or not any movement has occurred. Indeed, at least some of these calculations are performed for every frame even where there is a succession of frames that depict exactly the same image. While this may be appropriate for motion video, the result is a considerable waste of electric power when conveying video of a user interface and/or other computer-generated imagery in which there are typically relatively lengthy periods of time in which relatively little or no change occurs.

### BRIEF DESCRIPTION OF THE DRAWINGS

FIG. 1 illustrates an embodiment of a video presentation system.

FIG. 2 illustrates an alternate embodiment of a video presentation system.

FIG. 3 illustrates a degree of difference between two adjacent frames that include motion video.

FIG. 4 illustrates a degree of difference between two adjacent frames that do not include motion video.

FIGS. 5-6 each illustrate a portion of an embodiment.

FIGS. 7-9 each illustrate a logic flow according to an embodiment.

FIG. 10 illustrates a processing architecture according to an embodiment.

FIG. 11 illustrates another alternate embodiment of a graphics processing system.

FIG. 12 illustrates an embodiment of a device.

### DETAILED DESCRIPTION

Various embodiments are generally directed to techniques for reducing the consumption of electric power in compressing and transmitting video to a display device by analyzing a degree of difference between adjacent frames and dynamically selecting a type of compression per frame depending on the degree of difference. A relatively high degree of difference between adjacent frames may be deemed to indicate the inclusion of motion video such that a primary type of compression requiring greater consumption of electric power is appropriate. A relatively low degree of difference between adjacent frames may be deemed to indicate a lack of inclusion of motion video such that a secondary type of compression requiring less consumption of electric power is appropriate.

In some embodiments, a version of MPEG may be employed as the primary type of compression. In such embodiments, at least intra-frames (I-frames) incorporating data to describe an entire frame without reference to data associated with any other frame are transmitted in response to a current frame differing from a preceding adjacent frame to a relatively high degree. Further, predicted frames (P-frames) and/or bi-predicted frames (B-frames) incorporating data to describe how a current frame differs from one or more other frames in a manner that includes at least one motion vector may also be transmitted. In the generation of the I-frames, P-frames and/or B-frames, discrete cosine transform (DCT), quantization, motion compensation and other processor-intensive calculations may be employed as familiar to those skilled in the art of MPEG.

In some embodiments, a simpler coding technique based substantially on subtraction of pixel color values between adjacent frames may be employed as the secondary type of compression. In such embodiments, residual frames (R-frames) incorporating data to describe how pixel values of a current frame differ from those of its preceding adjacent frame are transmitted in response to a relatively low degree of such a difference. In comparison to such types of compression as MPEG, such subtraction to derive a R-frame employs far simpler calculations that may be performed relatively speedily by a processor component or by relatively simple subtraction logic implemented with circuitry that augments the processor component. Thus, such pixel-by-pixel subtraction is substantially less processor-intensive and thereby requires substantially less power to be consumed by a processor component than the calculations associated with MPEG.

Given that the R-frames are created in response to there being a relatively low degree of difference between adjacent frames, the R-frames are of a smaller data size than at least the I-frames, and may be of a smaller day data size than the P-frames and/or the B-frames. As a result, the R-frames require less electric power to transmit to a display device, in addition to requiring less electric power to be generated. A per-frame signal may also be transmitted to the display device indicating the type of frame for each frame transmitted, thereby indicating the type of compression employed to generate each frame transmitted.

In some embodiments, the display device may be signaled to repeat the visual presentation of an earlier transmitted frame in response to the degree of difference between a frame and its preceding frame being a lack of difference or a degree of difference deemed to be negligible. This may enable a momentary removal of electric power from a transmitting component of an interface employed in transmitting the compressed frames to the display device, at least until an instance of a current frame and its preceding adjacent frame having a greater degree of difference therebetween is encountered.

With general reference to notations and nomenclature used herein, portions of the detailed description which follows may be presented in terms of program procedures executed on a computer or network of computers. These procedural descriptions and representations are used by those skilled in the art to most effectively convey the substance of their work to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more embodiments. Rather, these operations are machine operations. Useful machines for performing operations of various embodiments include general purpose digital computers as selectively activated or configured by a computer program stored within that is written in accordance with the teachings herein, and/or include apparatus specially constructed for the required purpose. Various embodiments also relate to apparatus or systems for performing these operations. These apparatus may be specially constructed for the required purpose or may include a general purpose computer. The required structure for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives within the scope of the claims.

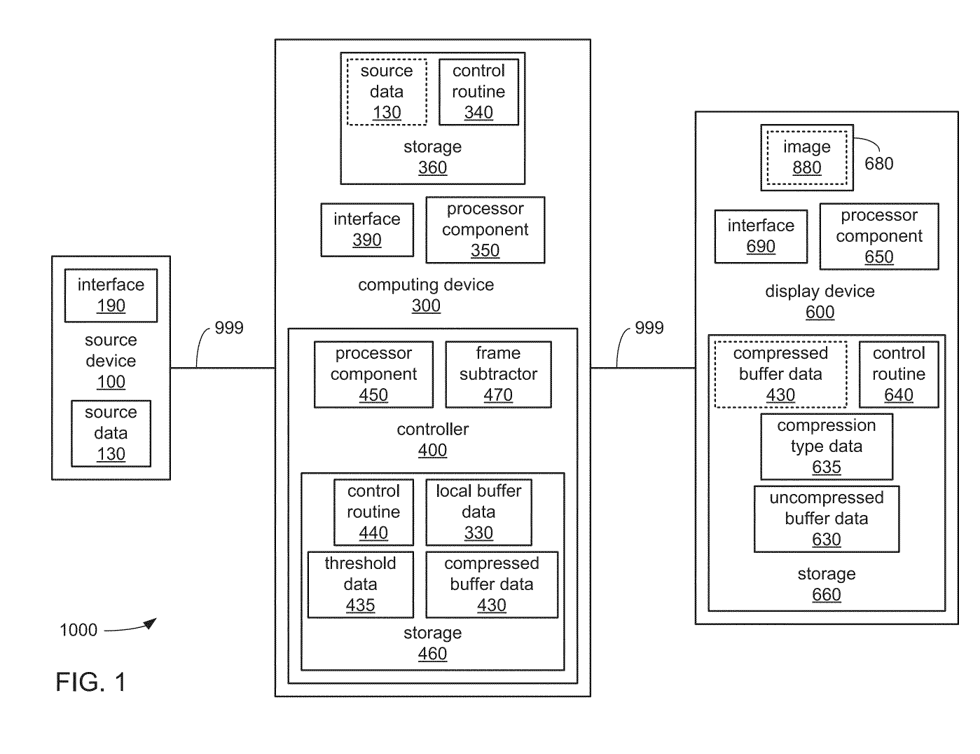

FIG. 1 illustrates a block diagram of an embodiment of a video presentation system 1000 incorporating one or more of a source device 100, a computing device 300 and a display device 600. In the video presentation system 1000, frames representing visual imagery 880 are compressed by the computing device 300 and are then transmitted to the display device 600 to be visually presented on a display 680. Each of these computing devices may be any of a variety of types of computing device, including without limitation, a desktop computer system, a data entry terminal, a laptop computer, a netbook computer, a tablet computer, a handheld personal data assistant, a smartphone, a digital camera, a body-worn computing device incorporated into clothing, a computing device integrated into a vehicle (e.g., a car, a bicycle, a wheelchair, etc.), a server, a cluster of servers, a server farm, etc.

As depicted, these computing devices 100, 300 and 600 exchange signals conveying compressed frames representing visual imagery and/or related data through a network 999. However, one or more of these computing devices may exchange other data entirely unrelated to visual imagery with each other and/or with still other computing devices (not shown) via the network 999. In various embodiments, the network may be a single network that may be limited to extending within a single building or other relatively limited area, a combination of connected networks that may extend a considerable distance, and/or may include the Internet. Thus, the network 999 may be based on any of a variety (or combination) of communications technologies by which signals may be exchanged, including without limitation, wired technologies employing electrically and/or optically conductive cabling, and wireless technologies employing infrared, radio frequency or other forms of wireless transmission.

In various embodiments, the source device 100 (if present) incorporates an interface 190 to couple the source device 100 to the computing device 300 to provide the computing device 300 with frames of visual imagery of a source data 130. As depicted, the interface 190 may couple the source device 100 to the computing device 300 through the same network 999 as couples the computing device 300 to the display device 500. However, in other embodiments, the source device 100 may be coupled to the computing device 300 in an entirely different manner. The frames may incorporate motion video in which objects move about in a manner causing a relatively high degree of difference between at least some adjacent ones of those frames. The frames may be provided to the computing device 300 in compressed form employing any of a variety of compression techniques familiar to those skilled in the art.

In various embodiments, the computing device 300 incorporates one or more of a processor component 350, a storage 360, a controller 400 and an interface 390 to couple the computing device 300 to the network 999. The storage 360 stores one or more of a source data 130 and a control routine 340. The controller 400 incorporates one or more of a processor component 450, a storage 460 and a frame subtractor 470. The storage 460 stores one or more of a local buffer data 330, a compressed buffer data 430, a threshold data 435 and a control routine 440.

The control routine 340 incorporates a sequence of instructions operative on the processor component 350 in its role as a main processor component of the computing device 300 to implement logic to perform various functions. In executing the control routine 340 in some embodiments, the processor component 350 receives the frames of the visual imagery 880 of the source data 130 from the source device 100, and may store at least a subset thereof in the storage 360. It should be noted that the source data 130 may be stored in the storage 360 for a considerable amount of time before any use is made of it, including transmission of its frames in compressed form to the display device 600 for visual presentation. Where those frames are received in compressed form, the processor component 350 may decompress them. The processor component 350 then provides those frames to the controller 400 in the local buffer data 330 as at least a part of the frames of the visual imagery 880 to be visually presented on the display 680.

Alternatively, in executing the control routine 340 in other embodiments, the processor component 350 generates a visual portion of a user interface that may include menus, visual representations of data, a visual representation of a current position of a pointer, etc. Such a visual portion of a user interface may be associated with an operating system of the computing device 300 and/or an application routine (not shown) executed by the processor component 350. The processor component 350 provides data representing the visual portion of the user interface to the controller 400 in the local buffer data 330 to be visually presented on the display 680 as at least a part of the visual imagery 880.

The control routine 440 incorporates a sequence of instructions operative on the processor component 450 in its role as a controller processor component of the controller 400 of the computing device 300 to implement logic to perform various functions. In executing the graphics routine 440, the processor component 450 compresses frames of the visual imagery 880 stored as the local buffer data 330, generating compressed versions of those frames and storing those compressed frames as part of the compressed buffer data 430. The processor circuit 450 may then encrypt those compressed frames before transmitting them to the display device 600 via the network 999.

As has been discussed, the frames of the visual imagery 880 stored in the local buffer 330 by the processor component 350 may include motion video (e.g., the source data 130 from the source device 100) and/or a visual portion of a user interface (e.g., a visual portion of a user interface generated by the processor component 350). Where those frames include motion video, it is envisioned that such frames may be directly stored in the storage 460 as at least a portion of the local buffer data 330 by the processor component 350. Where those frames include a visual portion of a user interface, such frames may be generated by the processor component 450 by recurringly capturing the state of the visual portion of that user interface generated by the processor component 350 at a regular interval. Such regular intervals may be associated with a refresh rate at which the visual imagery 880 is visually presented on the display 680.

Regardless of the manner in which frames of the visual imagery 880 are provided and/or generated in the local buffer data 330, the color values of each pixel of a current frame are subtracted from the color values of each corresponding pixel of the preceding adjacent frame (the frame that immediately precedes the current frame), or vice versa. This subtraction generates a difference frame indicating any differences in pixel color values therebetween. In some embodiments, such subtraction may be performed by the frame subtractor 470 implemented with digital circuitry to enable speedy performance of such subtraction. In other embodiments, such subtraction may be caused by the control routine 440 to be performed by the processor component 450.

In some embodiments, the pixel color values of the difference frame are directly analyzed to determine a degree of difference between the current frame and the preceding adjacent frame. In other embodiments, the difference frame is first compressed using a secondary type of compression to generate a residual frame (R-frame), and the data size of the R-frame (e.g., as measured as a number of bits or bytes) is used to determine a degree of difference. Regardless of the manner in which the degree of difference is determined, that degree of difference is compared to at least a first threshold of degree of difference specified in the threshold data 435.

In some embodiments, if the degree of difference is less than the first threshold, then the R-frame is transmitted to the display device 600, thereby conveying the current frame to the display device 600 as differences in the color values of its pixels from the preceding adjacent frame (e.g., the last frame transmitted to the display device 600). However, if the degree of difference is not less than the first threshold, then the current frame is compressed using a primary type of compression to generate a compressed frame that is transmitted to the display device 600. Where the primary type of compression is a version of MPEG, the type of frame generated by the primary type of compression may be an I-frame, a P-frame or a B-frame. Further, where the primary type of compression is a version of MPEG, the secondary type of compression may be Huffman coding. As will be explained in greater detail, a Huffman coding portion of the logic of the primary type of compression may also be used to perform the secondary type of compression.

In other embodiments, where primary type of compression is a version of MPEG, the degree of difference may also be compared to a second higher threshold of degree of difference. While the results of the comparison to the first threshold may determine whether the primary or secondary type of compression is used, the results of the comparison to the second threshold may determine whether an I-frame or one of a P-frame or a B-frame is generated by the primary type of compression.

Regardless of how types of compression are selected, the processor component 450 may be caused by execution of the control routine 440 to signal the display device 600 with indications of which types of compression are used in compressing each of those frames to generate the compressed frames that are transmitted to the display device 600. In some embodiments, such an indication of selection may be embedded in the transmission of each compressed frame that is transmitted.

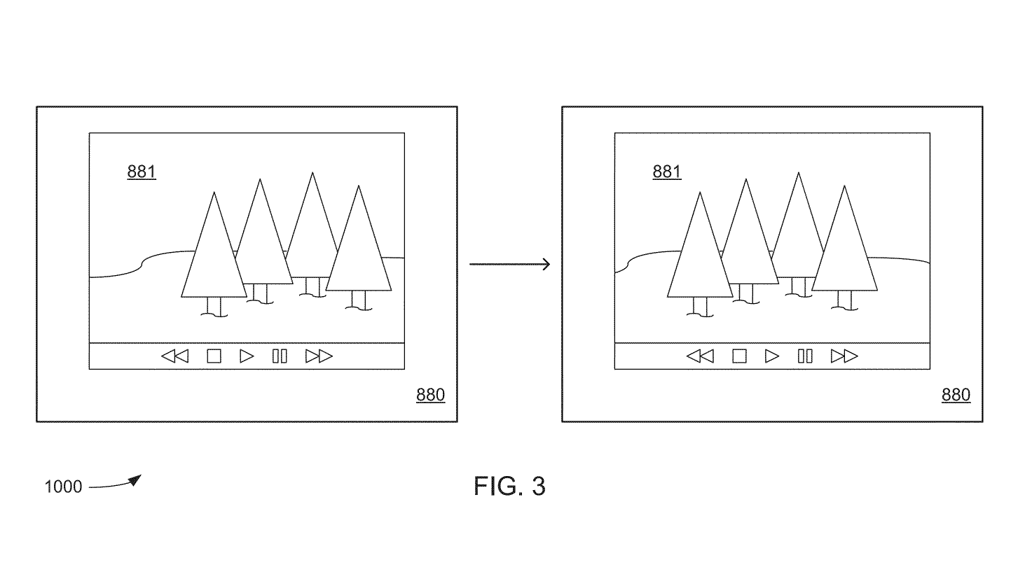

As previously discussed, it is envisioned that visual imagery that includes motion video is apt to generate relatively higher degrees of difference between adjacent frames than visual imagery that does not include motion video. FIG. 3 illustrates a degree of difference between adjacent frames of an example of the visual imagery 880 in which motion video is included. As can be seen in the transition from one adjacent frame to another, there is panning of motion video 881 captured by a motion video camera in which a stand of trees and surrounding terrain are caused to shift position. As can also be seen, the visual presentation of the stand of trees and surrounding terrain occupies a significant number of the pixels of the visual imagery 880 such that the shifting of these objects due to panning changes the state of a great many pixels. As a result, it is likely that a subtraction of corresponding pixel color values between these two adjacent frames would result in a difference frame that reveals a high degree of difference therebetween. In turn, it is likely that the primary type of compression (e.g., a version of MPEG) would tend to be dynamically selected. However, it is to be understood that instances in which there is little or no movement throughout the duration of two or more adjacent frames may still result in the selection of the second type of compression (e.g., Huffman coding).

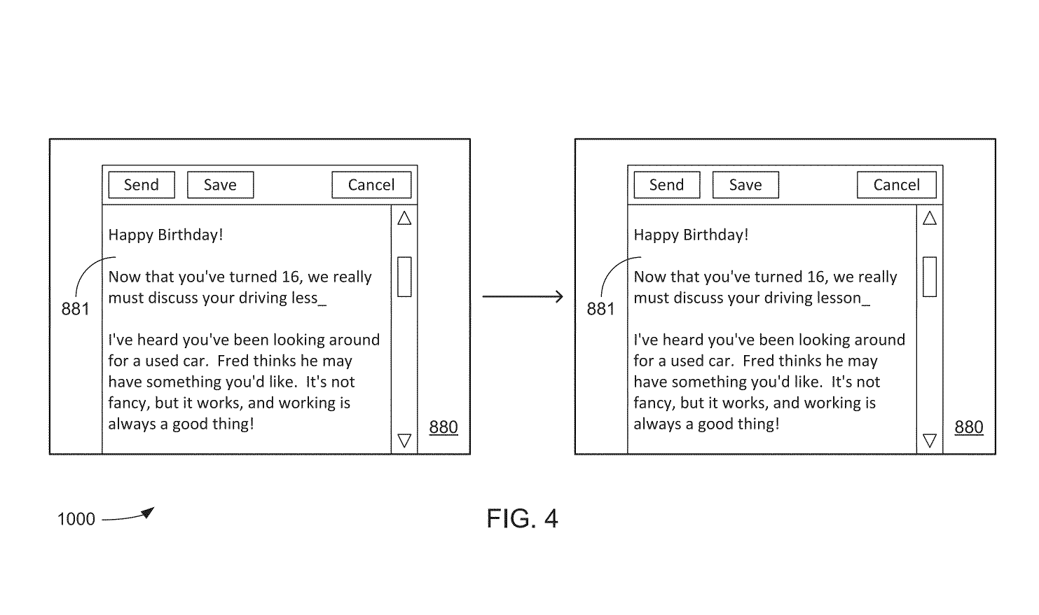

FIG. 4 illustrates a degree of difference between adjacent frames of another example of the visual imagery 880 in which no motion video is included. In contrast to the example of FIG. 3., the visual imagery 880 in the example of FIG. 4 is substantially occupied with a visual portion of a user interface of an example email text editing application. As can be seen in the transition from one adjacent frame to another, the typing of a line of text in the depicted email progresses only as far as adding the characters “on” to the characters “less” as part of the entry of the word “lessons” in this example. As can also be seen, this addition of two text characters in this progression from one adjacent frame to another affects relatively few pixels as all of the rest of what is depicted remains unchanged. Given that frame rates for displays are typically 60 to 75 frames per second, it is envisioned that only a relatively low degree of change is to be expected between adjacent frames during much of the time a visual portion of a user interface is visually presented as there are biomechanical limits to how quickly text or other input can be provided to the computing device 300. Indeed, where an operator of the computing device 300 pauses in providing input to read text or otherwise view a visual portion of a user interface, it is envisioned as likely that significant numbers of successive adjacent frames may have no differences whatsoever between them. In turn, it is likely that the secondary type of compression would tend to be dynamically selected. However, it is to be understood that instances in which there is a relatively high degree of change between adjacent frames (e.g., opening or closing an application, changing a page of a document, etc.) may still result in the selection of the first type of compression.

Returning to FIG. 1, in various embodiments, the computing device 600 incorporates one or more of a processor component 650, a storage 660, the display 680 and an interface 690 to couple the computing device 600 to the network 999. The storage 660 stores one or more of the compressed buffer data 430, a control routine 640, an uncompressed buffer data 630 and a compression type data 635.

Thus, the control routine 640 incorporates a sequence of instructions operative on the processor component 650 to implement logic to perform various functions. In executing the control routine 640, the processor component 650 receives the compressed frames of the compressed buffer data 430 from the computing device 300, storing at least a subset thereof in the storage 660. The processor component 650 also receives indications of the type of compression employed in compressing each of the compressed frames of the compressed buffer data 430, and stores those indications as the compression type data 635. The processor component 650 decompresses each of the compressed frames of the compressed buffer data 430 using whatever type of decompression that corresponds to the type of compression indicated for each of the compressed frames, and stores the resulting decompressed frames as the uncompressed buffer data 630. The processor component 650 then visually presents each of the decompressed frames of the uncompressed buffer data 630 on the display 680, thereby visually presenting the visual imagery 880 thereon.

It should be further noted that the compressed frames conveyed from the computing device 300 to the display device 600 may be encrypted as well as compressed. Thus, the controller 400 may additionally encrypt each of the compressed frames of the compressed buffer data 430 before transmitting them to the display device 600, and the processor component 650 may decrypt each of those frames after receiving them.

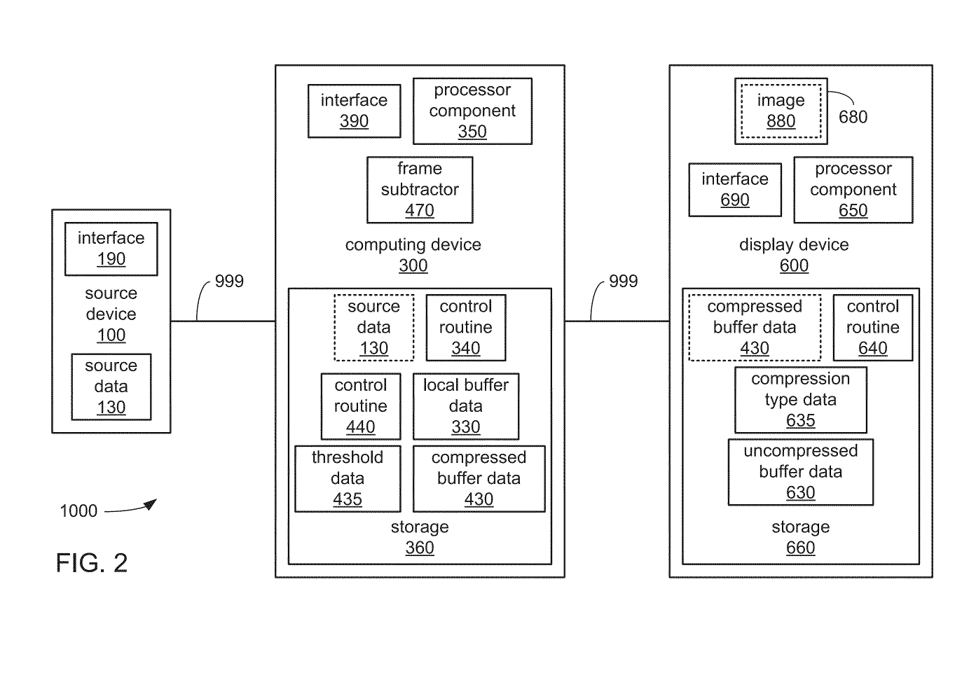

FIG. 2 illustrates a block diagram of an alternate embodiment of the video presentation system 1000 that includes an alternate embodiment of the computing device 300. The alternate embodiment of the video presentation system 1000 of FIG. 2 is similar to the embodiment of FIG. 1 in many ways, and thus, like reference numerals are used to refer to like elements throughout. However, unlike the computing device 300 of FIG. 1, the computing device 300 of FIG. 2 does not incorporate the controller 400. Also unlike the computing device 300 of FIG. 1, in the computing device 300 of FIG. 2, it is the processor component 350 that executes the control routine 440 in lieu of there being a processor component 450 to do so. Thus, in the alternate embodiment of the video presentation system 1000 of FIG. 2, the processor component 350 may compress and transmit the frames of the visual imagery 880, in addition to either receiving or generating those frames.

In various embodiments, each of the processor components 350, 450 and 650 may include any of a wide variety of commercially available processors. Further, one or more of these processor components may include multiple processors, a multi-threaded processor, a multi-core processor (whether the multiple cores coexist on the same or separate dies), and/or a multi-processor architecture of some other variety by which multiple physically separate processors are in some way linked.

Although each of the processor components 350, 450 and 650 may include any of a variety of types of processor, it is envisioned that the processor component 450 of the controller 400 (if present) may be somewhat specialized and/or optimized to perform tasks related to graphics and/or video. More broadly, it is envisioned that the controller 400 embodies a graphics subsystem of the computing device 300 to enable the performance of tasks related to graphics rendering, video compression, image resealing, etc., using components separate and distinct from the processor component 350 and its more closely related components.

In various embodiments, each of the storages 360, 460 and 660 may be based on any of a wide variety of information storage technologies. Such technologies may include volatile technologies requiring the uninterrupted provision of electric power and/or technologies entailing the use of machine-readable storage media that may or may not be removable. Thus, each of these storages may include any of a wide variety of types (or combination of types) of storage device, including without limitation, read-only memory (ROM), random-access memory (RAM), dynamic RAM (DRAM), Double-Data-Rate DRAM (DDR-DRAM), synchronous DRAM (SDRAM), static RAM (SRAM), programmable ROM (PROM), erasable programmable ROM (EPROM), electrically erasable programmable ROM (EEPROM), flash memory, polymer memory (e.g., ferroelectric polymer memory), ovonic memory, phase change or ferroelectric memory, silicon-oxide-nitride-oxide-silicon (SONOS) memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array). It should be noted that although each of these storages is depicted as a single block, one or more of these may include multiple storage devices that may be based on differing storage technologies. Thus, for example, one or more of each of these depicted storages may represent a combination of an optical drive or flash memory card reader by which programs and/or data may be stored and conveyed on some form of machine-readable storage media, a ferromagnetic disk drive to store programs and/or data locally for a relatively extended period, and one or more volatile solid state memory devices enabling relatively quick access to programs and/or data (e.g., SRAM or DRAM). It should also be noted that each of these storages may be made up of multiple storage components based on identical storage technology, but which may be maintained separately as a result of specialization in use (e.g., some DRAM devices employed as a main storage while other DRAM devices employed as a distinct frame buffer of a graphics controller).

In various embodiments, the interfaces 190, 390 and 690 may employ any of a wide variety of signaling technologies enabling these computing devices to be coupled to other devices as has been described. Each of these interfaces includes circuitry providing at least some of the requisite functionality to enable such coupling. However, each of these interfaces may also be at least partially implemented with sequences of instructions executed by corresponding ones of the processor components (e.g., to implement a protocol stack or other features). Where electrically and/or optically conductive cabling is employed, these interfaces may employ signaling and/or protocols conforming to any of a variety of industry standards, including without limitation, RS-232C, RS-422, USB, Ethernet (IEEE-802.3) or IEEE-1394. Where the use of wireless signal transmission is entailed, these interfaces may employ signaling and/or protocols conforming to any of a variety of industry standards, including without limitation, IEEE 802.11a, 802.11b, 802.11g, 802.16, 802.20 (commonly referred to as “Mobile Broadband Wireless Access”); Bluetooth; ZigBee; or a cellular radiotelephone service such as GSM with General Packet Radio Service (GSM/GPRS), CDMA/1 xRTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, etc.

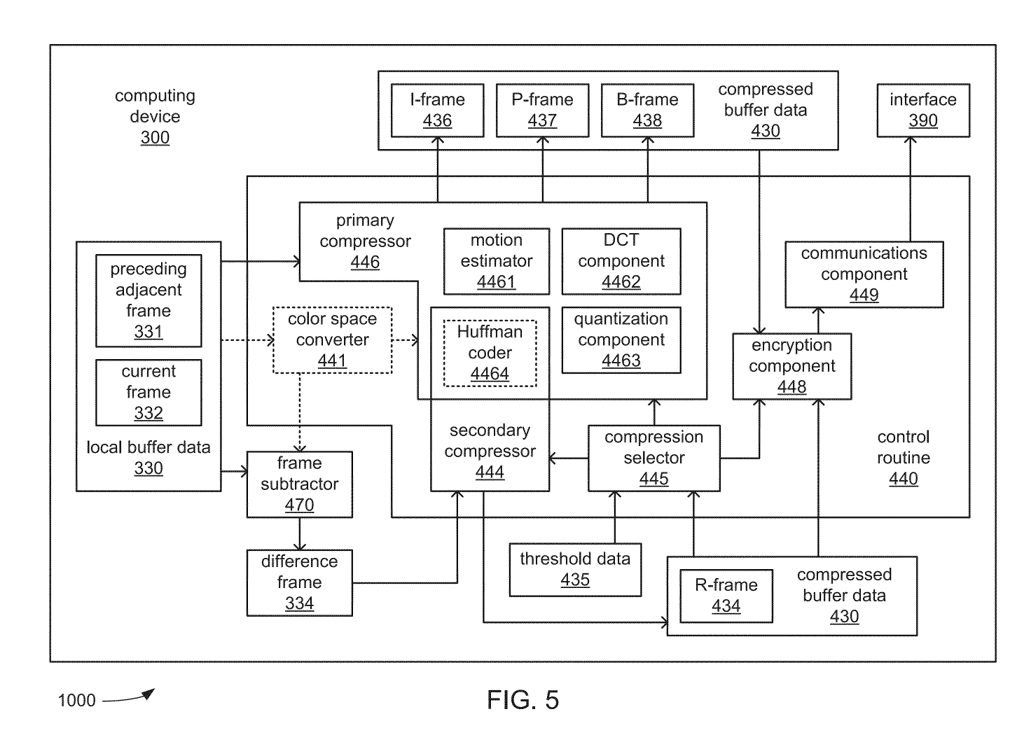

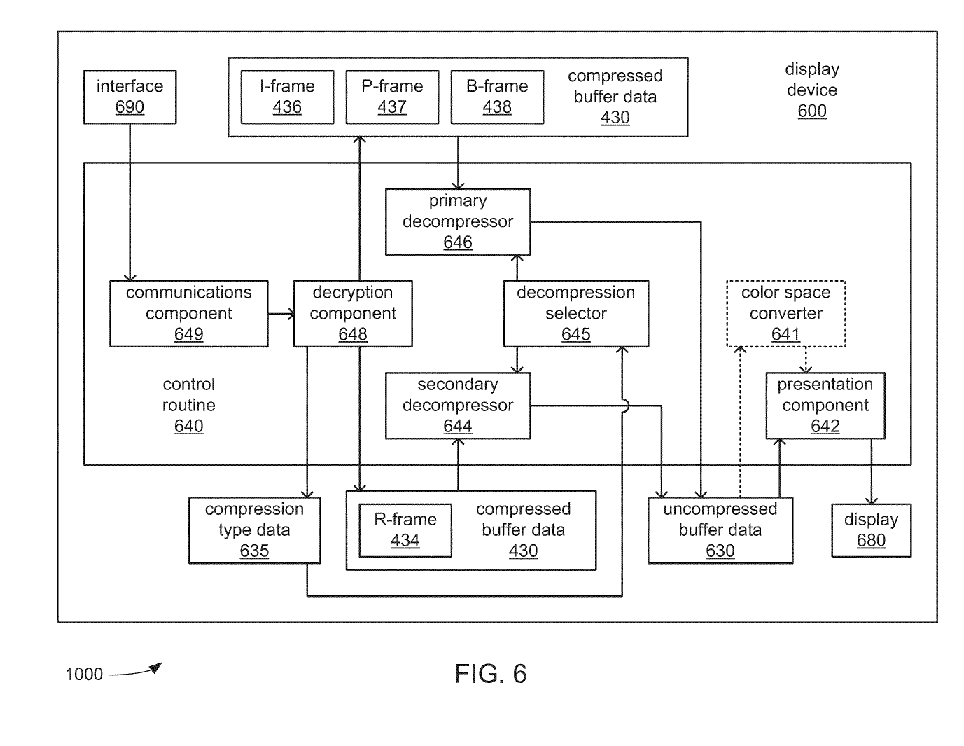

FIGS. 5 and 6 each illustrate a block diagram of a portion of an embodiment of the video presentation system 1000 of FIG. 1 in greater detail. More specifically, FIG. 5 depicts aspects of the operating environment of the computing device 300 in which either the processor component 350 or 450, in executing the control routine 440, compresses and transmits frames of the visual imagery 880. FIG. 6 depicts aspects of the operating environment of the display device 600 in which the processor component 650, in executing the control routine 640, decompresses and visually presents those frames on the display 680. As recognizable to those skilled in the art, the control routines 440 and 640, including the components of which each is composed, are selected to be operative on whatever type of processor or processors that are selected to implement applicable ones of the processor components 350, 450 or 650.

In various embodiments, each of the control routines 340, 440 and 640 may include one or more of an operating system, device drivers and/or application-level routines (e.g., so-called “software suites” provided on disc media, “applets” obtained from a remote server, etc.). Where an operating system is included, the operating system may be any of a variety of available operating systems appropriate for whatever corresponding ones of the processor components 350, 450 or 650. Where one or more device drivers are included, those device drivers may provide support for any of a variety of other components, whether hardware or software components, of corresponding ones of the computing devices 300 or 600, or the controller 400.

The control routines 440 or 640 may include a communications component 449 or 649, respectively, executable by whatever corresponding ones of the processor components 350, 450 or 550 to operate corresponding ones of the interfaces 390 or 690 to transmit and receive signals via the network 999 as has been described. Among the signals received may be signals conveying the source data 130 and/or the compressed buffer data 430 among one or more of the computing devices 100, 300 or 600 via the network 999. As will be recognized by those skilled in the art, each of these communications components is selected to be operable with whatever type of interface technology is selected to implement corresponding ones of the interfaces 390 or 690.

Turning more specifically to FIG. 5, the control routine 440 may include a color space converter 441 executable by the processor component 350 or 450 to convert the color space of frames of the local buffer data 330 (e.g., uncompressed frames representing the visual imagery 880), including a current frame 332 and a preceding adjacent frame 331. Where at least one of the types of compression performed by the control routine 440 includes MPEG, the color space converter 441 (if present) may convert frames of the local buffer data 330 from a red-green-blue (RGB) color space to luminance-chrominance (YUV) color space.

Regardless of the color space of the frames of the local buffer data 330 and regardless of whether their color space is converted to another, the frame subtractor 470 subtracts the current frame 332 from the preceding adjacent frame 331 (or vice versa) to derive a difference frame 334. In the difference frame 334, each pixel is given a color value representing a difference that may exist in color value between the corresponding pixels of the current frame 332 and the preceding adjacent frame 331. Although the frame subtractor 470 may be implemented as hardware-based logic in some embodiments, the frame subtractor 470 may be implemented as logic executable by the processor component 350 or 450 in other embodiments. In such other embodiments, the frame subtractor 470 may be a component of the control routine 440.

The control routine 440 includes a secondary compressor 444 executable by the processor component 350 or 450 to compress the difference frame 334 employing the secondary type of compression to generate a R-frame 434 stored as part of the compressed buffer data 430. As has been discussed, the secondary type of compression may include Huffman coding in some embodiments. Thus, the secondary compressor 444 may include a Huffman coder 4464.

The control routine 440 includes a primary compressor 446 executable by the processor component 350 or 450 to compress frames of the local buffer data 330 employing the primary type of compression. As has been discussed, the primary type of compression may include a version of MPEG. Thus, in compressing frames of the local buffer data 330, the primary compressor 446 may generate one or more of an I-frame 436, a P-frame 437 and a B-frame 438 stored as part of the compressed buffer data 430. Where the primary compressor 446 performs a version of MPEG, the primary compressor 446 may include one or more of a motion estimator 4461, a discrete cosine transform (DCT) component 4462, a quantization component 4463 and the Huffman coder 4464.

As familiar to those skilled in MPEG compression, the motion estimator 4461 analyzes adjacent frames of the local buffer data 330 to identify differences between frames arising from movement of objects such that sets of pixel color values associated with two-dimensional arrays of pixels shift in a particular direction. The motion estimator 4461 determines the direction and extent of such movement to enable one frame to be described relative to another frame at least partially with a indication of a motion vector. The DCT component 4462 transforms pixel color values of frames to a frequency domain, and the quantization component 4463 filters out higher frequency components. Such higher frequency components are often imperceptible and are therefore deemed acceptable to eliminate to reduce data size. It is at least this removal of higher frequency components that results in MPEG being classified as a lossy compression technique in which at least some of the visual information conveyed in frames is deliberately discarded. The Huffman coder 4464 performs entropy coding according to a code table (not shown) that assigns shorter bit-length descriptors to more frequently occurring data values and longer bit-length descriptors to less frequently occurring data values to reduce the number of bits required to describe the same data values.

As has been discussed, where the secondary type of compression includes Huffman coding and the primary type of compression includes a version of MPEG such that Huffman coding is employed by both types of compression, the logic to implement Huffman coding may be shared by both types of compression. Thus, as depicted in FIG. 5, the Huffman coder 4464 may be shared by the primary compressor 446 and the secondary compressor 444.

The control routine 440 includes a compression selector 445 executable by the processor component 350 or 450 to dynamically select compression by one or the other of the primary compressor 446 and the secondary compressor 444 to generate each frame transmitted to the display device 600. The compression selector 445 analyzes the data size of the R-frame 434 generated by the secondary compressor 444 in compressing the difference frame 334 and compares its data size to one or more thresholds indicated in the threshold data 435.

As has been discussed, if the data size of the R-frame 434 is less than one threshold, then the secondary type of compression employed by the secondary compressor 444 is selected, and the already generated R-frame 434 is selected to be transmitted to the display device 600 to represent the current frame 332 in compressed form. The R-frame 434 is used to describe the current frame 332 to the display device 600 in terms of how its pixel color values differ from those of the preceding adjacent frame 331.

As has also been discussed, if the data size of the R-frame 434 is not less than the one threshold, then the primary type of compression employed by the primary compressor 446 is selected. Thus, the primary compressor 446 is signaled by the compression selector 445 to generate one of the I-frame 436, the P-frame 437 or the B-frame 438 to be transmitted to the display device 600 to represent the current frame 332 in compressed form. In some embodiments, which of these three types of frame is generated by the primary compressor 446 from at least the current frame 332 is determined by the primary compressor 446 in a manner familiar to those skilled in MPEG compression. However, in other embodiments, the determination may be partially based on a comparison of data size of the R-frame 434 to another threshold. Where the data size of the R-frame 434 is less than the other threshold, then the compression selector 445 may signal the primary compressor 446 to generate one or the other of the P-frame 437 or the B-frame 438. However, where the data size of the R-frame 434 is not less than the other threshold, then the compression selector 445 may signal the primary compressor 446 to generate the I-frame 436.

The selection of one or both thresholds may be based on an analysis of typical data sizes of one or more of the R-frame 434, the I-frame 436, the P-frame 437 and the B-frame 438. Where the degree of difference between two adjacent frames is sufficiently small, the simpler description of one frame as a difference in pixel color values from an adjacent frame provided by the R-frame 434 is likely to have a smaller data size than can be achieved by any of the I-frame 436, the P-frame 437 or the B-frame 438. Where the degree of difference is somewhat greater, then one or the other of the P-frame 437 or the B-frame 438 is likely to have a smaller data size than can be achieved by either of the R-frame 434 or the I-frame 436. Where the degree of difference is considerably greater, then the entirely self-contained description of a complete frame provided by the I-frame 436 is likely to have a smaller data size than can be achieved by any of the R-frame 434, the P-frame 437 or the B-frame 438.

As has been discussed, generation of the R-frame 434 entails the use of relatively simpler and less processor-intensive calculations than are used in generating any of the I-frame 436, the P-frame 437 or the B-frame 438, thereby ultimately resulting in the consumption of less electric power. Thus, generation of R-frames may be deemed more desirable, even where the resulting data size of the R-frame 434 is somewhat larger than those of either the P-frame 437 or the B-frame 438, and the selection of one or both thresholds may reflect this in some embodiments.

The control routine 440 may include an encryption component 448 executable by the processor component 350 or 450 to encrypt compressed frames transmitted to the display device 600. Regardless of which type of compressed frame is generated and/or selected to represent the current frame 332, that frame is provided to the encryption component 448 (if present) to be encrypted by any of a variety of encryption techniques before being provided to the communications component 449 for transmission to the display device 600. The encryption component 448 may also encrypt indications transmitted to the display device 600 of which type of compression is employed to generate each of the transmitted compressed frames.

Turning more specifically to FIG. 6, the control routine 640 may include a decryption component 648 executable by the processor component 650 to decrypt the compressed frames that are received by the communications component 649 to reverse whatever type of encryption is employed by the encryption component 448. The decryption component 648 may then store the now decrypted compressed frames as the compressed buffer data 430 maintained by the display device 600. The decryption component 648 may also decrypt indications of the type of compression selected to compress each of those frames and store those indications as the compression type data 635.

The control routine 640 includes a primary decompressor 646 and a secondary decompressor 644 executable by the processor component 650 to decompress the compressed frames decrypted by the decryption component 648 using whichever type of decompression corresponds the type of compression employed in compressing them. More specifically, the primary decompressor 646 employs a type of decompression appropriate for decompressing frames compressed by the primary compressor 446, and the secondary decompressor 644 employs a type of decompression appropriate for decompressing frames compressed by the secondary compressor 444. Both of the decompressors 644 and 646 store the decompressed frames as part of the uncompressed buffer data 630. In a manner analogous to the compressors 444 and 446, where both of the decompressors 644 and 646 employ Huffman coding logic in performing decompression, the decompressors 644 and 646 may share logic employed in doing so.

The control routine 640 includes a decompression selector 645 executable by the processor component 650 to select the type of decompression employed in decompressing each of the compressed frames received by the decompressors 644 and 646 from the decryption component 648. This selection of type of decompression may be effected by the decompression selector 645 signaling one or the other of the decompressors 644 and 646 to decompress a particular compressed frame based on indications stored in the compression type data 635 of which type compression was employed in generating each compressed frame.

The control routine 640 may include a color space converter 641 executable by the processor component 650 to convert the color space of uncompressed frames of the uncompressed buffer data 630. Where at least one of the type of compression employed in compressing frames by the computing device 300 includes MPEG such that the control routine 440 includes the color space converter 441, the color space converter 641 (if present) may convert color spaces of the uncompressed frames of the uncompressed buffer data 630 from YUV back to RGB.

Regardless of the color space of the uncompressed frames of the uncompressed buffer data 630 and regardless of whether their color space is converted to another, the control routine 640 includes a presentation component 642 to visually present the uncompressed frames of the uncompressed buffer data 630 on the display 680. As familiar to those skilled in the art, the refresh rate at which the presentation component 648 provides frames for visual presentation on the display 680 may be selected to match or to be a multiple of the rate at which compressed frames are received by the display device 600 from the computing device 300.

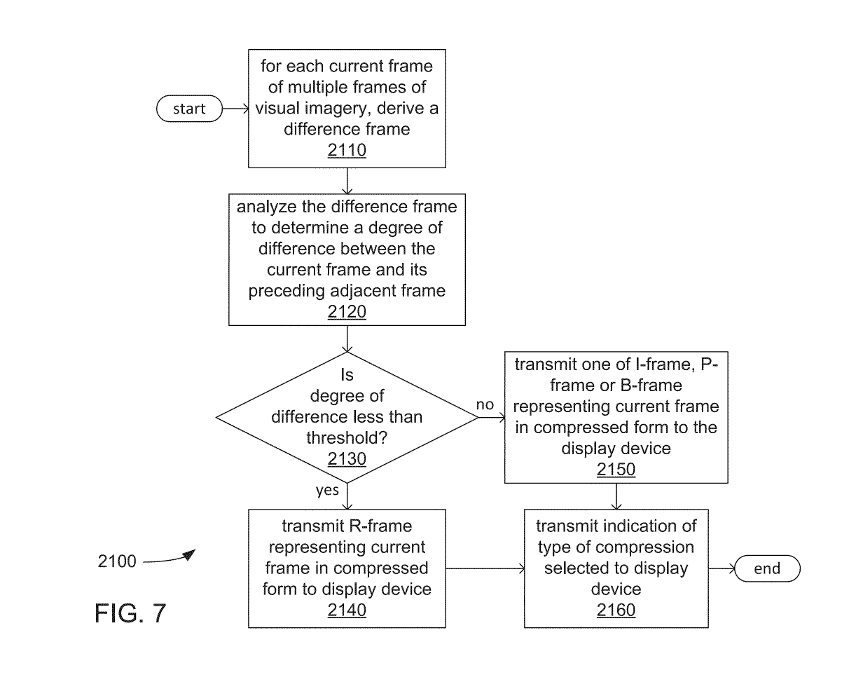

FIG. 7 illustrates one embodiment of a logic flow 2100. The logic flow 2100 may be representative of some or all of the operations executed by one or more embodiments described herein. More specifically, the logic flow 2100 may illustrate operations performed by the processor component 350 or 450 in executing at least the control routine 440, and/or performed by other component(s) of the computing device 300 or the controller 400, respectively.

At 2110, a processor component of a computing device (e.g., either the processor component 350 of the computing device 300, or the processor component 450 of the controller 400) derives a difference frame for each current frame of multiple frames representing visual imagery. As has been discussed, a difference frame is derived by subtracting one of a current frame and its preceding adjacent frame from the other such that the difference frame represents differences in pixel color values between the two.

At 2120, the difference frame is analyzed to determine a degree of difference between a current frame and its preceding adjacent frame. As has been discussed, the differences in pixel color values indicated in the difference frame may be directly analyzed to determine the degree of difference in some embodiments. However, in other embodiments, the difference frame is first compressed to generate a residual frame (R-frame), and then the data size of the R-frame is analyzed to determine the degree of difference. As has also been discussed, the type of compression employed in compressing the difference frame may include Huffman coding.

At 2130, the degree of difference is compared to a threshold of degree of difference. If the degree of difference is less than the threshold, then the aforementioned R-frame generated by compressing the difference frame is transmitted to the display device at 2140 to represent the current frame in a compressed form that describes the current frame in terms of how its pixel color values differ from its preceding adjacent frame. By selecting the R-frame to be transmitted, a selection of a type of compression (e.g., the type of compression used to generate the R-frame) is made, and an indication of this selection of a type of compression is then transmitted to the display device at 2160.

However, if the degree of difference at 2130 is not less than the threshold, then another type of compression is selected to compress the current frame to generate one of an I-frame, a P-frame or a B-frame that is transmitted to the display device at 2150 to represent the current frame in compressed form. As has been discussed, the type of compression employed in generating one or more of the I-frame, P-frame or B-frame may include a version of MPEG. Following such compression, the an indication of this selection of type of compression is transmitted to the display device at 2160.

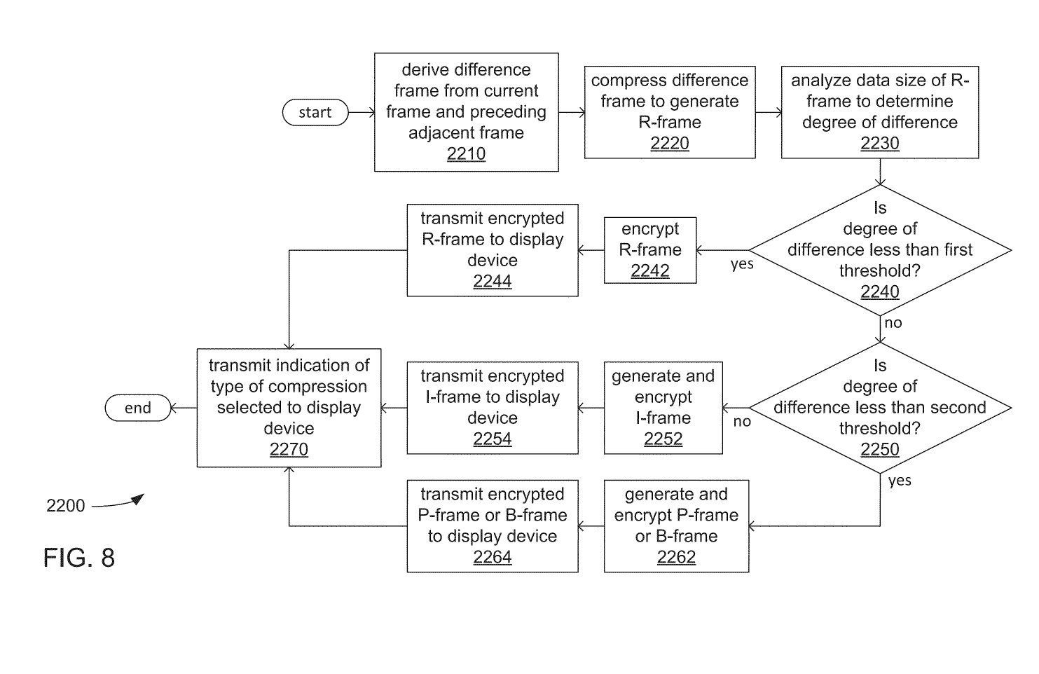

FIG. 8 illustrates one embodiment of a logic flow 2200. The logic flow 2200 may be representative of some or all of the operations executed by one or more embodiments described herein. More specifically, the logic flow 2200 may illustrate operations performed by the processor component 350 or 450 in executing at least the control routine 440, and/or performed by other component(s) of the computing device 300 or the controller 400, respectively.

At 2210, a processor component of a computing device (e.g., either the processor component 350 of the computing device 300, or the processor component 450 of the controller 400) derives a difference frame for each current frame of multiple frames representing visual imagery. As has been discussed, a difference frame is derived by subtracting one of a current frame and its preceding adjacent frame from the other such that the difference frame represents differences in pixel color values between the two.

At 2220, the difference frame is compressed to generate a residual frame (R-frame). As has been discussed, the type of compression employed to compress the difference frame may include Huffman coding. At 2230, the data size of the R-frame is analyzed to determine a degree of difference between a current frame and its preceding adjacent frame.

At 2240, the degree of difference is compared to a first threshold of degree of difference. If the degree of difference is less than the first threshold, then the aforementioned R-frame is encrypted at 2242 and transmitted to the display device at 2244 to represent the current frame in a compressed form that describes the current frame in terms of how its pixel color values differ from its preceding adjacent frame. By selecting the R-frame to be transmitted, a selection of a type of compression (e.g., the type of compression used to generate the R-frame) is made, and an indication of this selection of a type of compression is then transmitted to the display device at 2270.

However, if the degree of difference at 2240 is not less than the first threshold, then another type of compression is selected to compress the current frame to generate one of an I-frame, a P-frame or a B-frame that will be transmitted to the display device. As has been discussed, this other type of compress may include MPEG. At 2250, the degree of difference is compared to a second threshold of degree of difference that is greater than the first. If the degree of difference is not less than the second threshold, then the current frame is compressed using the other type of compression to generate an I-frame and the I-frame is encrypted at 2252. The encrypted I-frame is then transmitted to the display device at 2254, and an indication of this selection of the other type of compression is transmitted to the display device at 2270.

However, if the degree of difference at 2250 is less than the second threshold, then the current frame is compressed using the other type of compression to generate either a P-frame or a B-frame, and that P-frame or B-frame is encrypted at 2262. The encrypted P-frame or B-frame is then transmitted to the display device at 2264, and an indication of this selection of the other type of compression is transmitted to the display device at 2270.

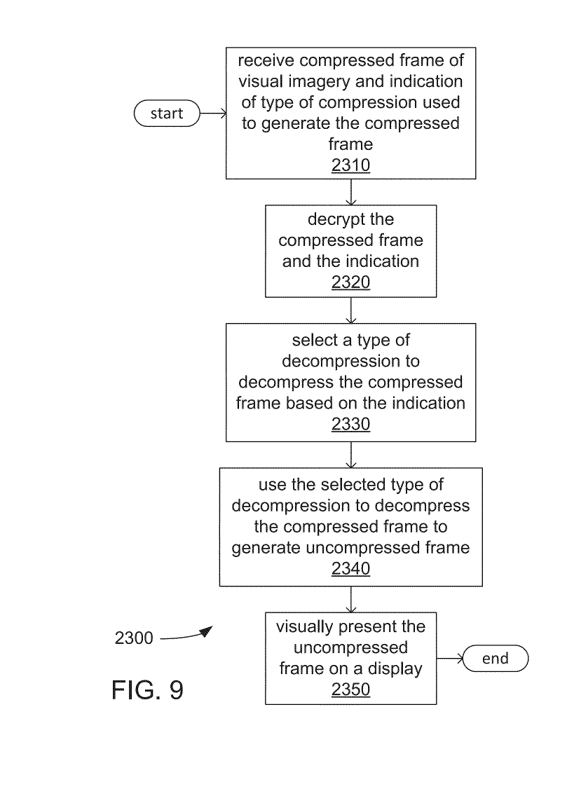

FIG. 9 illustrates one embodiment of a logic flow 2300. The logic flow 2300 may be representative of some or all of the operations executed by one or more embodiments described herein. More specifically, the logic flow 2300 may illustrate operations performed by the processor component 650 in executing at least the control routine 640, and/or performed by other component(s) of the display device 600.

At 2310, a processor component of a display device (e.g., the processor component 650 of the display device 600) receives a compressed frame of visual imagery and an indication of the type of compression selected and employed to generate the compressed frame. As has been discussed, the type of compression used may be dynamically selected per frame, and may include one or the other of Huffman coding or a version of MPEG. At 2320, the compressed frame and the indication of type of compression are decrypted.

At 2330, a type of decompression that matches the type compression used to generate the compressed frame is selected. Where the type of compression includes Huffman coding, then the type of decompression may also include Huffman coding, and where the type of compression includes a version of MPEG, then the type of decompression may also include MPEG. At 2340, the selected type of decompression is used to decompress the compressed frame and generate a corresponding uncompressed frame.

At 2350, the uncompressed frame is visually presented on a display of the display device. As has been discussed, the refresh rate at which uncompressed frames are visually presented on the display may be associated with the rate at which compressed frames are received by the display device (e.g., at the same rate or a multiple thereof).

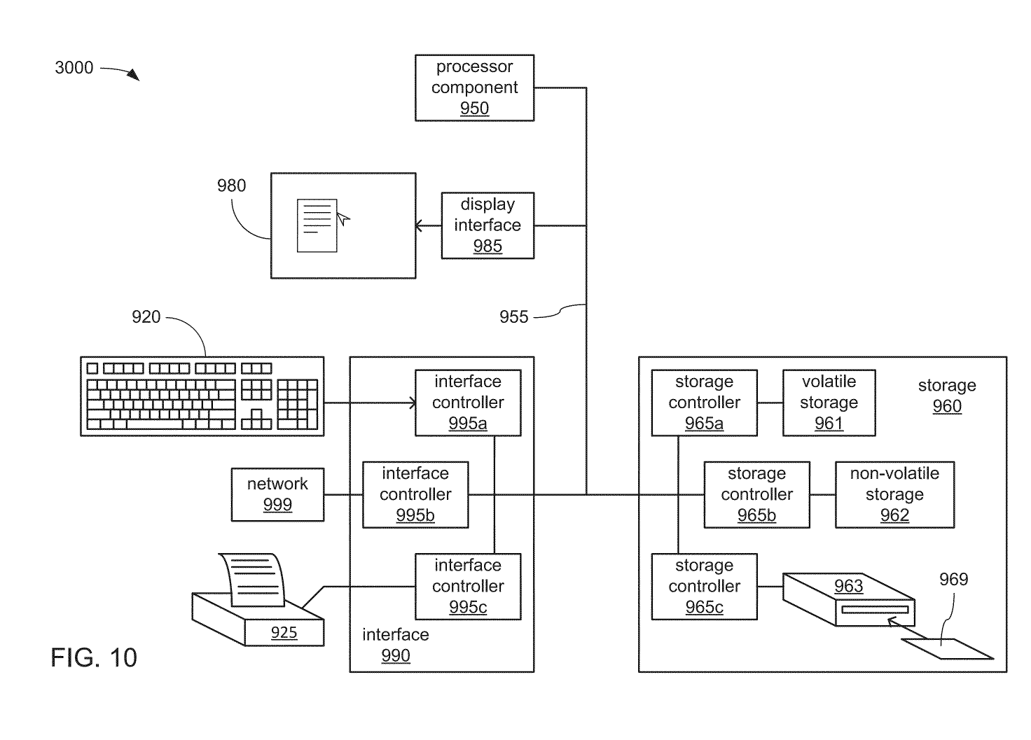

FIG. 10 illustrates an embodiment of an exemplary processing architecture 3000 suitable for implementing various embodiments as previously described. More specifically, the processing architecture 3000 (or variants thereof) may be implemented as part of one or more of the computing devices 100, 300, or 600, and/or the controller 400. It should be noted that components of the processing architecture 3000 are given reference numbers in which the last two digits correspond to the last two digits of reference numbers of at least some of the components earlier depicted and described as part of the computing devices 100, 300 and 600, as well as the controller 400. This is done as an aid to correlating components of each.

The processing architecture 3000 includes various elements commonly employed in digital processing, including without limitation, one or more processors, multi-core processors, co-processors, memory units, chipsets, controllers, peripherals, interfaces, oscillators, timing devices, video cards, audio cards, multimedia input/output (I/O) components, power supplies, etc. As used in this application, the terms “system” and “component” are intended to refer to an entity of a computing device in which digital processing is carried out, that entity being hardware, a combination of hardware and software, software, or software in execution, examples of which are provided by this depicted exemplary processing architecture. For example, a component can be, but is not limited to being, a process running on a processor component, the processor component itself, a storage device (e.g., a hard disk drive, multiple storage drives in an array, etc.) that may employ an optical and/or magnetic storage medium, an software object, an executable sequence of instructions, a thread of execution, a program, and/or an entire computing device (e.g., an entire computer). By way of illustration, both an application running on a server and the server can be a component. One or more components can reside within a process and/or thread of execution, and a component can be localized on one computing device and/or distributed between two or more computing devices. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to one or more signal lines. A message (including a command, status, address or data message) may be one of such signals or may be a plurality of such signals, and may be transmitted either serially or substantially in parallel through any of a variety of connections and/or interfaces.

As depicted, in implementing the processing architecture 3000, a computing device includes at least a processor component 950, a storage 960, an interface 990 to other devices, and a coupling 955. As will be explained, depending on various aspects of a computing device implementing the processing architecture 3000, including its intended use and/or conditions of use, such a computing device may further include additional components, such as without limitation, a display interface 985.

The coupling 955 includes one or more buses, point-to-point interconnects, transceivers, buffers, crosspoint switches, and/or other conductors and/or logic that communicatively couples at least the processor component 950 to the storage 960. Coupling 955 may further couple the processor component 950 to one or more of the interface 990, the audio subsystem 970 and the display interface 985 (depending on which of these and/or other components are also present). With the processor component 950 being so coupled by couplings 955, the processor component 950 is able to perform the various ones of the tasks described at length, above, for whichever one(s) of the aforedescribed computing devices implement the processing architecture 3000. Coupling 955 may be implemented with any of a variety of technologies or combinations of technologies by which signals are optically and/or electrically conveyed. Further, at least portions of couplings 955 may employ timings and/or protocols conforming to any of a wide variety of industry standards, including without limitation, Accelerated Graphics Port (AGP), CardBus, Extended Industry Standard Architecture (E-ISA), Micro Channel Architecture (MCA), NuBus, Peripheral Component Interconnect (Extended) (PCI-X), PCI Express (PCI-E), Personal Computer Memory Card International Association (PCMCIA) bus, HyperTransport™, QuickPath, and the like.

As previously discussed, the processor component 950 (corresponding to the processor components 350, 450 and 650) may include any of a wide variety of commercially available processors, employing any of a wide variety of technologies and implemented with one or more cores physically combined in any of a number of ways.

As previously discussed, the storage 960 (corresponding to the storages 360, 460 and 660) may be made up of one or more distinct storage devices based on any of a wide variety of technologies or combinations of technologies. More specifically, as depicted, the storage 960 may include one or more of a volatile storage 961 (e.g., solid state storage based on one or more forms of RAM technology), a non-volatile storage 962 (e.g., solid state, ferromagnetic or other storage not requiring a constant provision of electric power to preserve their contents), and a removable media storage 963 (e.g., removable disc or solid state memory card storage by which information may be conveyed between computing devices). This depiction of the storage 960 such that it may include multiple distinct types of storage is in recognition of the commonplace use of more than one type of storage device in computing devices in which one type provides relatively rapid reading and writing capabilities enabling more rapid manipulation of data by the processor component 950 (but which may use a “volatile” technology constantly requiring electric power) while another type provides relatively high density of non-volatile storage (but likely provides relatively slow reading and writing capabilities).

Given the often different characteristics of different storage devices employing different technologies, it is also commonplace for such different storage devices to be coupled to other portions of a computing device through different storage controllers coupled to their differing storage devices through different interfaces. By way of example, where the volatile storage 961 is present and is based on RAM technology, the volatile storage 961 may be communicatively coupled to coupling 955 through a storage controller 965a providing an appropriate interface to the volatile storage 961 that perhaps employs row and column addressing, and where the storage controller 965a may perform row refreshing and/or other maintenance tasks to aid in preserving information stored within the volatile storage 961. By way of another example, where the non-volatile storage 962 is present and includes one or more ferromagnetic and/or solid-state disk drives, the non-volatile storage 962 may be communicatively coupled to coupling 955 through a storage controller 965b providing an appropriate interface to the non-volatile storage 962 that perhaps employs addressing of blocks of information and/or of cylinders and sectors. By way of still another example, where the removable media storage 963 is present and includes one or more optical and/or solid-state disk drives employing one or more pieces of machine-readable storage medium 969, the removable media storage 963 may be communicatively coupled to coupling 955 through a storage controller 965c providing an appropriate interface to the removable media storage 963 that perhaps employs addressing of blocks of information, and where the storage controller 965c may coordinate read, erase and write operations in a manner specific to extending the lifespan of the machine-readable storage medium 969.

One or the other of the volatile storage 961 or the non-volatile storage 962 may include an article of manufacture in the form of a machine-readable storage media on which a routine including a sequence of instructions executable by the processor component 950 may be stored, depending on the technologies on which each is based. By way of example, where the non-volatile storage 962 includes ferromagnetic-based disk drives (e.g., so-called “hard drives”), each such disk drive typically employs one or more rotating platters on which a coating of magnetically responsive particles is deposited and magnetically oriented in various patterns to store information, such as a sequence of instructions, in a manner akin to storage medium such as a floppy diskette. By way of another example, the non-volatile storage 962 may be made up of banks of solid-state storage devices to store information, such as sequences of instructions, in a manner akin to a compact flash card. Again, it is commonplace to employ differing types of storage devices in a computing device at different times to store executable routines and/or data. Thus, a routine including a sequence of instructions to be executed by the processor component 950 may initially be stored on the machine-readable storage medium 969, and the removable media storage 963 may be subsequently employed in copying that routine to the non-volatile storage 962 for longer term storage not requiring the continuing presence of the machine-readable storage medium 969 and/or the volatile storage 961 to enable more rapid access by the processor component 950 as that routine is executed.

As previously discussed, the interface 990 (corresponding to the interfaces 190, 390 or 690) may employ any of a variety of signaling technologies corresponding to any of a variety of communications technologies that may be employed to communicatively couple a computing device to one or more other devices. Again, one or both of various forms of wired or wireless signaling may be employed to enable the processor component 950 to interact with input/output devices (e.g., the depicted example keyboard 920 or printer 925) and/or other computing devices through a network (e.g., the network 999) or an interconnected set of networks. In recognition of the often greatly different character of multiple types of signaling and/or protocols that must often be supported by any one computing device, the interface 990 is depicted as including multiple different interface controllers 995a, 995b and 995c. The interface controller 995a may employ any of a variety of types of wired digital serial interface or radio frequency wireless interface to receive serially transmitted messages from user input devices, such as the depicted keyboard 920. The interface controller 995b may employ any of a variety of cabling-based or wireless signaling, timings and/or protocols to access other computing devices through the depicted network 999 (perhaps a network made up of one or more links, smaller networks, or perhaps the Internet). The interface 995c may employ any of a variety of electrically conductive cabling enabling the use of either serial or parallel signal transmission to convey data to the depicted printer 925. Other examples of devices that may be communicatively coupled through one or more interface controllers of the interface 990 include, without limitation, microphones, remote controls, stylus pens, card readers, finger print readers, virtual reality interaction gloves, graphical input tablets, joysticks, other keyboards, retina scanners, the touch input component of touch screens, trackballs, various sensors, a camera or camera array to monitor movement of persons to accept commands and/or data signaled by those persons via gestures and/or facial expressions, laser printers, inkjet printers, mechanical robots, milling machines, etc.

Where a computing device is communicatively coupled to (or perhaps, actually incorporates) a display (e.g., the depicted example display 980), such a computing device implementing the processing architecture 3000 may also include the display interface 985. Although more generalized types of interface may be employed in communicatively coupling to a display, the somewhat specialized additional processing often required in visually displaying various forms of content on a display, as well as the somewhat specialized nature of the cabling-based interfaces used, often makes the provision of a distinct display interface desirable. Wired and/or wireless signaling technologies that may be employed by the display interface 985 in a communicative coupling of the display 980 may make use of signaling and/or protocols that conform to any of a variety of industry standards, including without limitation, any of a variety of analog video interfaces, Digital Video Interface (DVI), DisplayPort, etc.

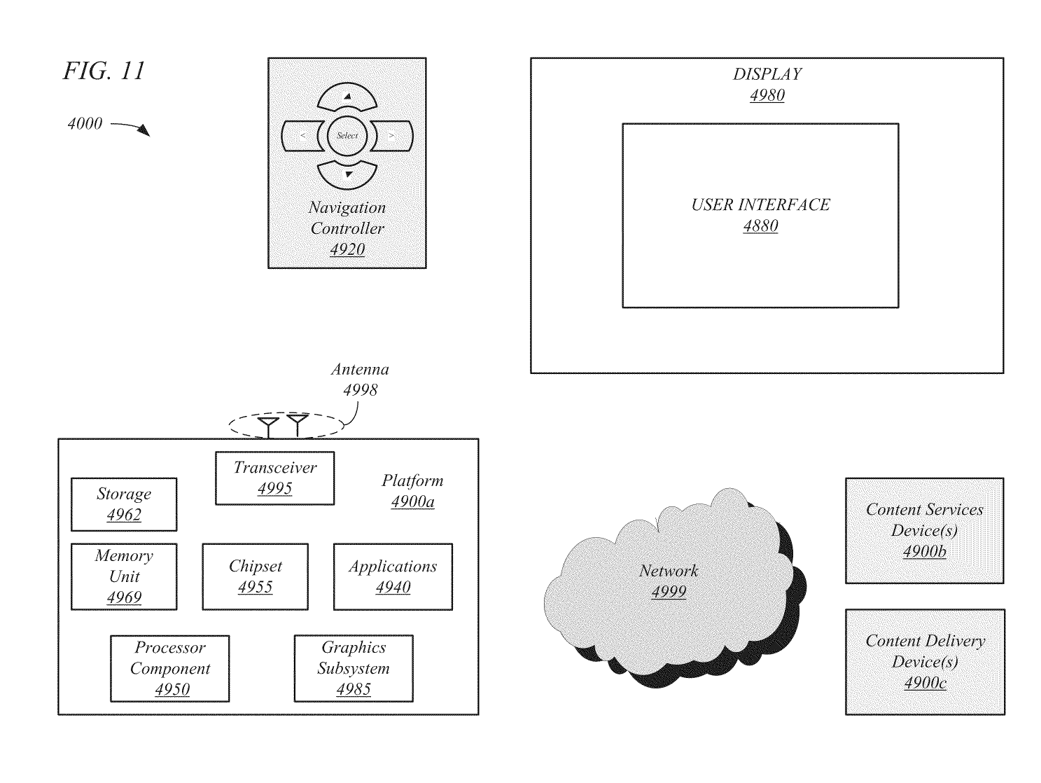

FIG. 11 illustrates an embodiment of a system 4000. In various embodiments, system 4000 may be representative of a system or architecture suitable for use with one or more embodiments described herein, such as the graphics processing system 1000; one or more of the computing devices 100, 300 or 600; and/or one or both of the logic flows 2100 or 2200. The embodiments are not limited in this respect.

As shown, system 4000 may include multiple elements. One or more elements may be implemented using one or more circuits, components, registers, processors, software subroutines, modules, or any combination thereof, as desired for a given set of design or performance constraints. Although FIG. 11 shows a limited number of elements in a certain topology by way of example, it can be appreciated that more or less elements in any suitable topology may be used in system 4000 as desired for a given implementation. The embodiments are not limited in this context.

In embodiments, system 4000 may be a media system although system 4000 is not limited to this context. For example, system 4000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 4000 includes a platform 4900a coupled to a display 4980. Platform 4900a may receive content from a content device such as content services device(s) 4900c or content delivery device(s) 4900d or other similar content sources. A navigation controller 4920 including one or more navigation features may be used to interact with, for example, platform 4900a and/or display 4980. Each of these components is described in more detail below.

In embodiments, platform 4900a may include any combination of a processor component 4950, chipset 4955, memory unit 4969, transceiver 4995, storage 4962, applications 4940, and/or graphics subsystem 4985. Chipset 4955 may provide intercommunication among processor circuit 4950, memory unit 4969, transceiver 4995, storage 4962, applications 4940, and/or graphics subsystem 4985. For example, chipset 4955 may include a storage adapter (not depicted) capable of providing intercommunication with storage 4962.

Processor component 4950 may be implemented using any processor or logic device, and may be the same as or similar to one or more of processor components 150, 350 or 650, and/or to processor component 950 of FIG. 10.

Memory unit 4969 may be implemented using any machine-readable or computer-readable media capable of storing data, and may be the same as or similar to storage media 969 of FIG. 10.

Transceiver 4995 may include one or more radios capable of transmitting and receiving signals using various suitable wireless communications techniques, and may be the same as or similar to transceiver 995b in FIG. 10.

Display 4980 may include any television type monitor or display, and may be the same as or similar to one or more of displays 380 and 680, and/or to display 980 in FIG. 10.

Storage 4962 may be implemented as a non-volatile storage device, and may be the same as or similar to non-volatile storage 962 in FIG. 10.

Graphics subsystem 4985 may perform processing of images such as still or video for display. Graphics subsystem 4985 may be a graphics processing unit (GPU) or a visual processing unit (VPU), for example. An analog or digital interface may be used to communicatively couple graphics subsystem 4985 and display 4980. For example, the interface may be any of a High-Definition Multimedia Interface, DisplayPort, wireless HDMI, and/or wireless HD compliant techniques. Graphics subsystem 4985 could be integrated into processor circuit 4950 or chipset 4955. Graphics subsystem 4985 could be a stand-alone card communicatively coupled to chipset 4955.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

In embodiments, content services device(s) 4900b may be hosted by any national, international and/or independent service and thus accessible to platform 4900a via the Internet, for example. Content services device(s) 4900b may be coupled to platform 4900a and/or to display 4980. Platform 4900a and/or content services device(s) 4900b may be coupled to a network 4999 to communicate (e.g., send and/or receive) media information to and from network 4999. Content delivery device(s) 4900c also may be coupled to platform 4900a and/or to display 4980.

In embodiments, content services device(s) 4900b may include a cable television box, personal computer, network, telephone, Internet enabled devices or appliance capable of delivering digital information and/or content, and any other similar device capable of unidirectionally or bidirectionally communicating content between content providers and platform 4900a and/display 4980, via network 4999 or directly. It will be appreciated that the content may be communicated unidirectionally and/or bidirectionally to and from any one of the components in system 4000 and a content provider via network 4999. Examples of content may include any media information including, for example, video, music, medical and gaming information, and so forth.

Content services device(s) 4900b receives content such as cable television programming including media information, digital information, and/or other content. Examples of content providers may include any cable or satellite television or radio or Internet content providers. The provided examples are not meant to limit embodiments.

In embodiments, platform 4900a may receive control signals from navigation controller 4920 having one or more navigation features. The navigation features of navigation controller 4920 may be used to interact with a user interface 4880, for example. In embodiments, navigation controller 4920 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of navigation controller 4920 may be echoed on a display (e.g., display 4980) by movements of a pointer, cursor, focus ring, or other visual indicators displayed on the display. For example, under the control of software applications 4940, the navigation features located on navigation controller 4920 may be mapped to virtual navigation features displayed on user interface 4880. In embodiments, navigation controller 4920 may not be a separate component but integrated into platform 4900a and/or display 4980. Embodiments, however, are not limited to the elements or in the context shown or described herein.

In embodiments, drivers (not shown) may include technology to enable users to instantly turn on and off platform 4900a like a television with the touch of a button after initial boot-up, when enabled, for example. Program logic may allow platform 4900a to stream content to media adaptors or other content services device(s) 4900b or content delivery device(s) 4900c when the platform is turned “off.” In addition, chip set 4955 may include hardware and/or software support for 5.1 surround sound audio and/or high definition 7.1 surround sound audio, for example. Drivers may include a graphics driver for integrated graphics platforms. In embodiments, the graphics driver may include a peripheral component interconnect (PCI) Express graphics card.

In various embodiments, any one or more of the components shown in system 4000 may be integrated. For example, platform 4900a and content services device(s) 4900b may be integrated, or platform 4900a and content delivery device(s) 4900c may be integrated, or platform 4900a, content services device(s) 4900b, and content delivery device(s) 4900c may be integrated, for example. In various embodiments, platform 4900a and display 4890 may be an integrated unit. Display 4980 and content service device(s) 4900b may be integrated, or display 4980 and content delivery device(s) 4900c may be integrated, for example. These examples are not meant to limit embodiments.

In various embodiments, system 4000 may be implemented as a wireless system, a wired system, or a combination of both. When implemented as a wireless system, system 4000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 4000 may include components and interfaces suitable for communicating over wired communications media, such as I/O adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 4900a may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 11.

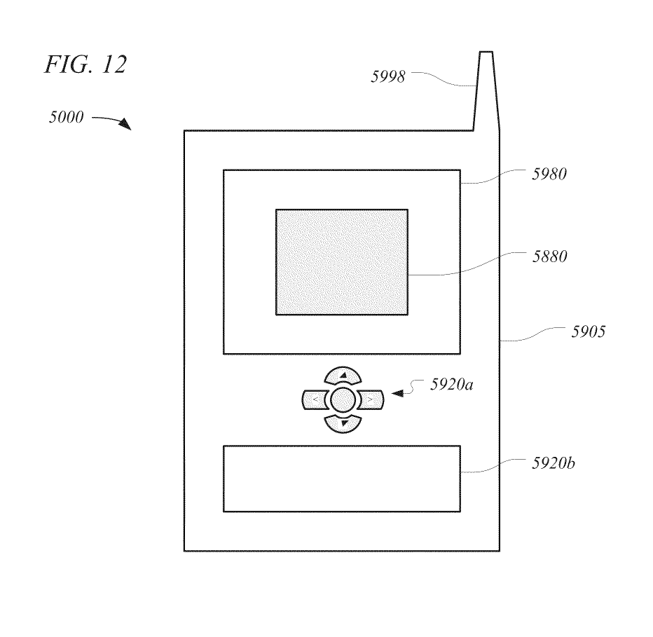

As described above, system 4000 may be embodied in varying physical styles or form factors. FIG. 12 illustrates embodiments of a small form factor device 5000 in which system 4000 may be embodied. In embodiments, for example, device 5000 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 12, device 5000 may include a display 5980, a navigation controller 5920a, a user interface 5880, a housing 5905, an I/O device 5920b, and an antenna 5998. Display 5980 may include any suitable display unit for displaying information appropriate for a mobile computing device, and may be the same as or similar to display 4980 in FIG. 11. Navigation controller 5920a may include one or more navigation features which may be used to interact with user interface 5880, and may be the same as or similar to navigation controller 4920 in FIG. 11. I/O device 5920b may include any suitable I/O device for entering information into a mobile computing device. Examples for I/O device 5920b may include an alphanumeric keyboard, a numeric keypad, a touch pad, input keys, buttons, switches, rocker switches, microphones, speakers, voice recognition device and software, and so forth. Information also may be entered into device 5000 by way of a microphone. Such information may be digitized by a voice recognition device. The embodiments are not limited in this context.

More generally, the various elements of the computing devices described and depicted herein may include various hardware elements, software elements, or a combination of both. Examples of hardware elements may include devices, logic devices, components, processors, microprocessors, circuits, processor components, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other. Furthermore, aspects or elements from different embodiments may be combined.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims. The detailed disclosure now turns to providing examples that pertain to further embodiments. The examples provided below are not intended to be limiting.

In some examples, a device to compress video frames may include a processor component, and a compression selector for execution by the processor component to dynamically select a type of compression for a current frame of a series of frames based on a degree of difference between the current frame and a preceding adjacent frame of the series of frames.

Additionally or alternatively, the device may include a frame subtractor to derive a difference frame that includes a difference in pixel color of at least one pixel between the current frame and the preceding adjacent frame, and the compression selector may analyze the difference frame to determine the degree of difference.

Additionally or alternatively, the device may include a frame subtractor to derive a difference frame that includes a difference in pixel color of at least one pixel between the current frame and the preceding adjacent frame, and a Huffman coder for execution by the processor component to compress the difference frame to generate a residual frame (R-frame) that represents the current frame in compressed form, where the compression selector may determine the degree of difference based on a data size of the R-frame.

Additionally or alternatively, the device may include a primary compressor for execution by the processor component to employ a primary type of compression to compress the current frame, and a secondary compressor for execution by the processor component to employ a secondary type of compression to compress the current frame, where the compression selector may select the primary or secondary compressor to compress the current frame based on a comparison of the degree of difference to a selected threshold.

Additionally or alternatively, the primary type of compression may include a version of Motion Picture Experts Group (MPEG), and the secondary type of compression may include Huffman coding.

Additionally or alternatively, the device may include a Huffman coder for execution by the processor component, and the Huffman coder may be shared by the primary compressor and the secondary compressor.

Additionally or alternatively, the primary compressor may include a motion estimator, a discrete cosine transform (DCT) component, a quantization component and a Huffman coder to generate one of an intra-frame (I-frame), a predicted frame (P-frame) or a bi-predicted frame (B-frame) that represents the current frame in compressed form.

Additionally or alternatively, the compression selector may signal the primary compressor to generate the I-frame or to generate one of the P-frame and the B-frame based on the degree of difference.

Additionally or alternatively, the secondary compressor may compress a difference frame that includes a difference in pixel color of at least one pixel between the current frame and the preceding adjacent frame to generate a residual frame (R-frame) to represent the current frame in compressed form.

Additionally or alternatively, the device may include an encryption component for execution by the processor component to encrypt a compressed frame that represents the current frame in compressed form following compression of the current frame by the selected type of compression.

Additionally or alternatively, the device may include an interface to transmit the compressed frame and an indication of selection of the type of compression to compress the current frame to a display device following compression of the current frame and encryption of the compressed frame.

In some examples, a device to decompress video frames may include a processor component, an interface to receive multiple compressed frames of visual imagery and indications of type of compression employed to generate each compressed frame of the multiple compressed frames, and a decompression selector for execution by the processor component to select a type of decompression to decompress each compressed frame of the multiple compressed frames based on the indications.

Additionally or alternatively, the device may include a primary decompressor for execution by the processor component to employ a primary type of decompression to decompress a compressed frame, and a secondary decompressor for execution by the processor component to employ a secondary type of decompression to decompress a compressed frame, and the decompression selector may select the primary or secondary decompressor to decompress each compressed frame of the multiple compressed frames based on the indications.

Additionally or alternatively, the primary type of decompression may include a version of Motion Picture Experts Group (MPEG), and the secondary type of compression may include Huffman coding.

Additionally or alternatively, the device may include a decryption component for execution by the processor component to decrypt the multiple compressed frames and the indications prior selection of the selected type of decompression.

Additionally or alternatively, the device may include a color space converter for execution by the processor component to convert a color space of each compressed frame of the multiple compressed frames following decompression of each compressed frame.

Additionally or alternatively, the device may include a display to visually present each compressed frame of the multiple compressed frames following decompression of each compressed frame.

In some examples, a computer-implemented method for compressing video frames may include subtracting pixel color values of one of a current frame of a series of frames and a preceding adjacent frame of the series of frames from corresponding pixel color values of another of the current frame and the preceding adjacent frame to determine a degree of difference, and dynamically selecting a type of compression to compress the current frame based on the degree of difference.

Additionally or alternatively, the method may include generating a difference frame that includes a difference in pixel color of at least one pixel between the current frame and the preceding adjacent frame, and analyzing the difference frame to determine the degree of difference.

Additionally or alternatively, the method may include generating a difference frame that includes a difference in pixel color of at least one pixel between the current frame and the preceding adjacent frame, employing Huffman coding to compress the difference frame to generate a residual frame (R-frame) that represents the current frame in compressed form, and determining the degree of difference from a data size of the R-frame.

Additionally or alternatively, the method may include selecting a primary type of compression to compress the current frame or a secondary type of compression to compress the current frame based on a comparison of the degree of difference to a selected threshold.

Additionally or alternatively, the primary type of compression may include a version of Motion Picture Experts Group (MPEG), and the secondary type of compression may include Huffman coding.

Additionally or alternatively, the method may include generating one of an intra-frame (I-frame), a predicted frame (P-frame) or a bi-predicted frame (B-frame) that represents the current frame in compressed form in response to selecting the primary type of compression.

Additionally or alternatively, the method may include generating the I-frame or generating one of the P-frame and the B-frame based on the degree of difference.

Additionally or alternatively, the method may include compressing the difference frame to generate a residual frame (R-frame) to represent the current frame in compressed form in response to selecting the secondary type of compression.

Additionally or alternatively, the method may include encrypting a compressed frame representing the current frame in compressed form following compression of the current frame by the selected type of compression.

Additionally or alternatively, the method may include transmitting the compressed frame and an indication of selection of the type of compression to compress the current frame to a display device following compression of the current frame and encryption of the compressed frame.

In some examples, at least one machine-readable storage medium may include instructions that when executed by a computing device, cause the computing device to subtract pixel color values of one of a current frame of a series of frames and a preceding adjacent frame of the series of frames from corresponding pixel color values of another of the current frame and the preceding adjacent frame to determine a degree of difference, and dynamically select a type of compression to compress the current frame based on the degree of difference.

Additionally or alternatively, the computing device may be caused to generate a difference frame that includes a difference in pixel color of at least one pixel between the current frame and the preceding adjacent frame, and analyze the difference frame to determine the degree of difference.

Additionally or alternatively, the computing device may be caused to generate a difference frame that includes a difference in pixel color of at least one pixel between the current frame and the preceding adjacent frame, employ Huffman coding to compress the difference frame to generate a residual frame (R-frame) that represents the current frame in compressed form, and determine the degree of difference from a data size of the R-frame.

Additionally or alternatively, the computing device may be caused to select a primary type of compression to compress the current frame or a secondary type of compression to compress the current frame based on a comparison of the degree of difference to a selected threshold.

Additionally or alternatively, the primary type of compression may include a version of Motion Picture Experts Group (MPEG), and the secondary type of compression may include Huffman coding.

Additionally or alternatively, the computing device may be caused to generate one of an intra-frame (I-frame), a predicted frame (P-frame) or a bi-predicted frame (B-frame) that represents the current frame in compressed form in response to selecting the primary type of compression.

Additionally or alternatively, the computing device may be caused to generate the I-frame or generate one of the P-frame and the B-frame based on the degree of difference.

Additionally or alternatively, the computing device may be caused to compress the difference frame to generate a residual frame (R-frame) to represent the current frame in compressed form in response to selecting the secondary type of compression.

Additionally or alternatively, the computing device may be caused to encrypt a compressed frame representing the current frame in compressed form following compression of the current frame by the selected type of compression.

Additionally or alternatively, the computing device may be caused to transmit the compressed frame and an indication of selection of the type of compression to compress the current frame to a display device following compression of the current frame and encryption of the compressed frame.

In some examples a computer-implemented method for decompressing video frames may include receiving multiple compressed frames of visual imagery and indications of type of compression employed to generate each compressed frame of the multiple compressed frames, and selecting a type of decompression to decompress each compressed frame of the multiple compressed frames based on the indications.

Additionally or alternatively, the method may include selecting a primary type of decompression to decompress a compressed frame of the multiple compressed frames or a secondary type of decompression to decompress the compressed frame based on the indications.

Additionally or alternatively, the primary type of decompression may include a version of Motion Picture Experts Group (MPEG), and the secondary type of compression may include Huffman coding.

Additionally or alternatively, the method may include decrypting the multiple compressed frames prior to decompression by the selected type of decompression.

Additionally or alternatively, the method may include decrypting the indications prior to selection of the selected type of decompression.

Additionally or alternatively, the method may include converting a color space of each compressed frame of the multiple compressed frames following decompression of each compressed frame.

Additionally or alternatively, the method may include presenting each compressed frame of the multiple compressed frames on a display following decompression of each compressed frame.

In some examples, at least one machine-readable storage medium may include instructions that when executed by a computing device, cause the computing device to receive multiple compressed frames of visual imagery and indications of type of compression employed to generate each compressed frame of the multiple compressed frames, and select a type of decompression to decompress each compressed frame of the multiple compressed frames based on the indications.

Additionally or alternatively, the computing device may be caused to select a primary type of decompression to decompress a compressed frame of the multiple compressed frames or a secondary type of decompression to decompress the compressed frame based on the indications.

Additionally or alternatively, the primary type of decompression may be a version of Motion Picture Experts Group (MPEG), and the secondary type of compression may include Huffman coding.

Additionally or alternatively, the computing device may be caused to decrypt the multiple compressed frames prior to decompression by the selected type of decompression.

Additionally or alternatively, the computing device may be caused to decrypt the indications prior to selection of the selected type of decompression.

Additionally or alternatively, the computing device may be caused to convert a color space of each compressed frame of the multiple compressed frames following decompression of each compressed frame.

Additionally or alternatively, the computing device may be caused to visually present each compressed frame of the multiple compressed frames on a display of the computing device following decompression of each compressed frame.

In some embodiments, at least one machine-readable storage medium may include instructions that when executed by a computing device, cause the computing device to perform any of the above.

In some embodiments, an device to compress and/or visually present video frames may include means for performing any of the above.

1-25. (canceled)

26. A device to compress video frames comprising:
a processor component; and
a compression selector for execution by the processor component to dynamically select a type of compression for a current frame of a series of frames based on a degree of difference between the current frame and a preceding adjacent frame of the series of frames.

27. The device of claim 26, comprising:
a frame subtractor to derive a difference frame comprising a difference in pixel color of at least one pixel between the current frame and the preceding adjacent frame; and
a Huffman coder for execution by the processor component to compress the difference frame to generate a residual frame (R-frame) that represents the current frame in compressed form, the compression selector to determine the degree of difference based on a data size of the R-frame.

28. The device of claim 26, comprising:
a primary compressor for execution by the processor component to employ a primary type of compression to compress the current frame; and
a secondary compressor for execution by the processor component to employ a secondary type of compression to compress the current frame, the compression selector to select the primary or secondary compressor to compress the current frame based on a comparison of the degree of difference to a selected threshold.

29. The device of claim 28, comprising a Huffman coder for execution by the processor component, the Huffman coder shared by the primary compressor and the secondary compressor.

30. The device of claim 28, the secondary compressor to compress a difference frame comprising a difference in pixel color of at least one pixel between the current frame and the preceding adjacent frame to generate a residual frame (R-frame) to represent the current frame in compressed form.

31. The device of claim 26, comprising an encryption component for execution by the processor component to encrypt a compressed frame that represents the current frame in compressed form following compression of the current frame by the selected type of compression.

32. The device of claim 31, comprising an interface to transmit the compressed frame and an indication of selection of the type of compression to compress the current frame to a display device following compression of the current frame and encryption of the compressed frame.

33. A device to decompress video frames comprising:
a processor component;
an interface to receive multiple compressed frames of visual imagery and indications of type of compression employed to generate each compressed frame of the multiple compressed frames; and
a decompression selector for execution by the processor component to select a type of decompression to decompress each compressed frame of the multiple compressed frames based on the indications.

34. The device of claim 33, comprising:
a primary decompressor for execution by the processor component to employ a primary type of decompression to decompress a compressed frame; and
a secondary decompressor for execution by the processor component to employ a secondary type of decompression to decompress a compressed frame, the decompression selector to select the primary or secondary decompressor to decompress each compressed frame of the multiple compressed frames based on the indications.

35. The device of claim 33, comprising a decryption component for execution by the processor component to decrypt the multiple compressed frames and the indications prior selection of the selected type of decompression.

36. The device of claim 33, comprising a color space converter for execution by the processor component to convert a color space of each compressed frame of the multiple compressed frames following decompression of each compressed frame.

37. The device of claim 33, comprising a display to visually present each compressed frame of the multiple compressed frames following decompression of each compressed frame.

38. A computer-implemented method for compressing video frames comprising:
subtracting pixel color values of one of a current frame of a series of frames and a preceding adjacent frame of the series of frames from corresponding pixel color values of another of the current frame and the preceding adjacent frame to determine a degree of difference; and
dynamically selecting a type of compression to compress the current frame based on the degree of difference.

39. The computer-implemented method of claim 38, the method comprising:
generating a difference frame comprising a difference in pixel color of at least one pixel between the current frame and the preceding adjacent frame; and
analyzing the difference frame to determine the degree of difference.

40. The computer-implemented method of claim 38, the method comprising:
generating a difference frame comprising a difference in pixel color of at least one pixel between the current frame and the preceding adjacent frame;
employing Huffman coding to compress the difference frame to generate a residual frame (R-frame) that represents the current frame in compressed form; and
determining the degree of difference from a data size of the R-frame.

41. The computer-implemented method of claim 38, the method comprising selecting a primary type of compression to compress the current frame or a secondary type of compression to compress the current frame based on a comparison of the degree of difference to a selected threshold.

42. The computer-implemented method of claim 41, the method comprising generating one of an intra-frame (I-frame), a predicted frame (P-frame) or a bi-predicted frame (B-frame) that represents the current frame in compressed form in response to selecting the primary type of compression.

43. The computer-implemented method of claim 42, the method comprising generating the I-frame or generating one of the P-frame and the B-frame based on the degree of difference.

44. The computer-implemented method of claim 41, the method comprising compressing the difference frame to generate a residual frame (R-frame) to represent the current frame in compressed form in response to selecting the secondary type of compression.

45. At least one machine-readable storage medium comprising instructions that when executed by a computing device, cause the computing device to:
subtract pixel color values of one of a current frame of a series of frames and a preceding adjacent frame of the series of frames from corresponding pixel color values of another of the current frame and the preceding adjacent frame to determine a degree of difference; and
dynamically select a type of compression to compress the current frame based on the degree of difference.

46. The at least one machine-readable storage medium of claim 45, the computing device caused to select a primary type of compression to compress the current frame or a secondary type of compression to compress the current frame based on a comparison of the degree of difference to a selected threshold.

47. The at least one machine-readable storage medium of claim 46, the computing device caused to generate one of an intra-frame (I-frame), a predicted frame (P-frame) or a bi-predicted frame (B-frame) that represents the current frame in compressed form in response to selecting the primary type of compression.

48. The at least one machine-readable storage medium of claim 46, the computing device caused to compress the difference frame to generate a residual frame (R-frame) to represent the current frame in compressed form in response to selecting the secondary type of compression.

49. The at least one machine-readable storage medium of claim 45, the computing device caused to encrypt a compressed frame representing the current frame in compressed form following compression of the current frame by the selected type of compression.

50. The at least one machine-readable storage medium of claim 49, the computing device caused to transmit the compressed frame and an indication of selection of the type of compression to compress the current frame to a display device following compression of the current frame and encryption of the compressed frame.
